(19) United States
(12) Patent Application Publication
(10) Pub. No.: US 2013/0173465 A1
(43) Pub. Date: Jul. 4, 2013

(54) SYSTEM AND METHOD TO FACILITATE PURCHASES ON MOBILE DEVICES VIA AUTOMATIC PAYMENT CONFIRMATION

(71) Applicant: FORTUMO OU, Tartu (EE)

(72) Inventors: Tauno TALIMAA, Tartu (EE); Madis PINK, Tartu (EE); Tanel KOSK, Tartu (EE); Gerri KODRES, Tartu (EE); Andrei DEMENTJEV, Tartu (EE)

(73) Assignee: FORTUMO OU, Tartu (EE)

(21) Appl. No.: 13/686,578

(22) Filed: Nov. 27, 2012

Related U.S. Application Data
(60) Provisional application No. 61/563,801, filed on Nov. 27, 2011.

(51) Int. Cl. G06Q 20/42

(52) U.S. Cl. CPC G06Q 20/42
USPC 705/40

(57) ABSTRACT

System and method to facilitate purchases through mobile communications on various mobile devices by reducing the number of steps it takes the user to complete the purchase with mobile in-application payments. The payment confirmation is provided using platform's native user experience interface. User is informed about the price of the purchase, respective terms of use and the choice of confirming or cancelling the purchase. Once the purchase is confirmed by pressing the payment confirmation button, respective controller handles the process of performing the payment confirmation request via SMS text message. Confirmation request is done in the background without the need of any involvement of the user. After the payment is confirmed by mobile carrier a confirmation dialogue is displayed to user using native platform interface.

### FIELD OF INVENTION

The present invention relates to the field of mobile payments, more specifically to the field of systems and methods for enabling automatic payment confirmation requests for purchases on mobile devices.

### BACKGROUND OF THE INVENTION

It is known to perform purchases of goods or services using a mobile device. For example, a user may purchase a song while browsing a mobile website. Or pay for additional content inside mobile game or application. There are various methods and technologies, that allow a user to perform purchases on a mobile device, including but not limited to those provided by mobile operating system manufacturer, handset vendors, mobile carriers and banks.

The main disadvantage of existing methods for making purchases on mobile devices via mobile carrier billing is the need for the user to manually confirm each purchase by sending a text message, entering a ZIP code or visiting special web page. This makes bad user experience and thus reduced conversion rate and turnover.

### BRIEF DESCRIPTION OF THE INVENTION

The aim of present invention is to provide a system and method to facilitate purchases through mobile communications on various mobile devices including but not limited to smartphones, feature phones and tablet computers by reducing the number of steps it takes the user (for example the purchaser, buyer, end-client, shopper, etc) to complete the purchase with mobile in-application payments.

One of the payment confirmation methods is a so-called double opt-in algorithm, when after sending the initial payment request via an SMS text message to a premium rate short code purchaser is asked to confirm the payment by sending another SMS text message with text “YES” to same premium rate short code thus confirming the price of transaction and finalizing the payment. Payment confirmation is required by mobile carriers in order to prevent fraud and non-authorized purchases.

With the help of present solution payment confirmation is provided using platform's native user experience interface. User is informed about the price of the purchase, respective terms of use and the choice of confirming or cancelling the purchase. Once the purchase is confirmed by pressing the payment confirmation button, respective controller handles the process of performing the payment confirmation request via SMS text message.

Confirmation request is done in the background without the need of any involvement of the user. After the payment is confirmed by mobile carrier a confirmation dialogue is displayed to user using native platform interface.

The advantage of the present invention from the user perspective is that the time-consuming step of filling and sending additional payment confirmation request SMS message is excluded from the purchase flow. The whole payment process is more smooth and effective without the risk of input errors. As a result, the process of purchase on mobile device feels like an initial and built-in functionality of the handset provided by mobile carrier.

The advantage of the present invention from the merchant perspective is the increased simplicity of completing the purchase for the user. This leads to higher amount of purchases, less interrupted payments and increased revenues.

A system to facilitate mobile purchases via automatic payment confirmation comprises a data computing facility, which is connected to mobile carrier billing infrastructure and a plurality of converters to communicate and interface with a plurality of controllers for various types of mobile devices and platforms.

Respective controller integrates with platform's native interface in order to obtain transaction confirmation and inform the user about successful transaction.

Each converter is configured to communicate with a respective controller through an active internet connection (for example mobile broadband or wireless) using HTML protocol. Respective payment confirmation request data is served to respective converter by the computing facility in accordance to XML 1.0 specification produced by the W3C and includes technical information including but not limited to premium short code, SMS message text and sending delay.

Sending payment confirmation request via SMS message is performed by respective controller through interrogating with messaging component of the device using native methods.

Each controller is designed to integrate with respective device's platform interface based on device's operating system. In case respective controller is not able to integrate with platform's native interface, an universal HTML5 markup language based web interface is used as communication interface. Operating system detection is performed by converter based on user agent property according to RFC 1945.

A method to facilitate mobile purchases via automatic payment confirmation comprises following steps:
Device controller requests confirmation request details from remote converter;
Remote converter requests confirmation request details from DCF (Data Computing Facility). DCF forwards confirmation request details to remote converter;
Confirmation request details are sent to device controller by remote converter in XML format. Device controller initiates carrier payment confirmation process;
Mobile carrier requests user to confirm the payment via SMS text message;
Carrier's confirmation request is intercepted by messaging component and forwarded to device controller;
Checking whether the mobile carrier's confirmation request details match the information obtained from remote converter;
   In case mobile carrier's confirmation request details match the information obtained from remote converter, payment confirmation request details are sent to messaging component;
   In case details do not match, user is asked to confirm the payment manually;
Payment confirmation request is made by sending a SMS text message by messaging component;
Successful billing confirmation request is made to messaging component by mobile carrier informing about successful billing;
Billing confirmation is forwarded to device controller.

A method where automatic double opt-in payment confirmation algorithm is used to facilitate purchases through mobile communications on various mobile devices by reducing the number of steps it takes the user to complete the purchase with mobile in-application payments whereas according to double opt-in payment confirmation algorithm, after sending the initial payment request via an SMS text message to a premium rate short code user is asked to manually confirm the transaction by sending another SMS text message with confirmation text to same premium rate short code thus confirming the price of transaction and finalizing the payment.

A system where with the help of respective solution payment confirmation is provided using platform's native user experience interface, thereafter the user is informed about the price of the purchase, respective terms of use and the choice of confirming or cancelling the purchase.

A system where once the purchase is confirmed by pressing the payment confirmation button respective controller handles the process of performing the payment confirmation request via SMS text message and the confirmation request is done in the background without the need of any involvement of the user.

A system where when the payment is confirmed by mobile carrier a confirmation dialogue is displayed to user using native platform interface.

### BRIEF DESCRIPTION OF THE DRAWINGS

The present invention is explained more precisely with references to figures added, where

FIG. 1 depicts an illustrative system for facilitating purchases on mobile devices via automatic payment confirmation;

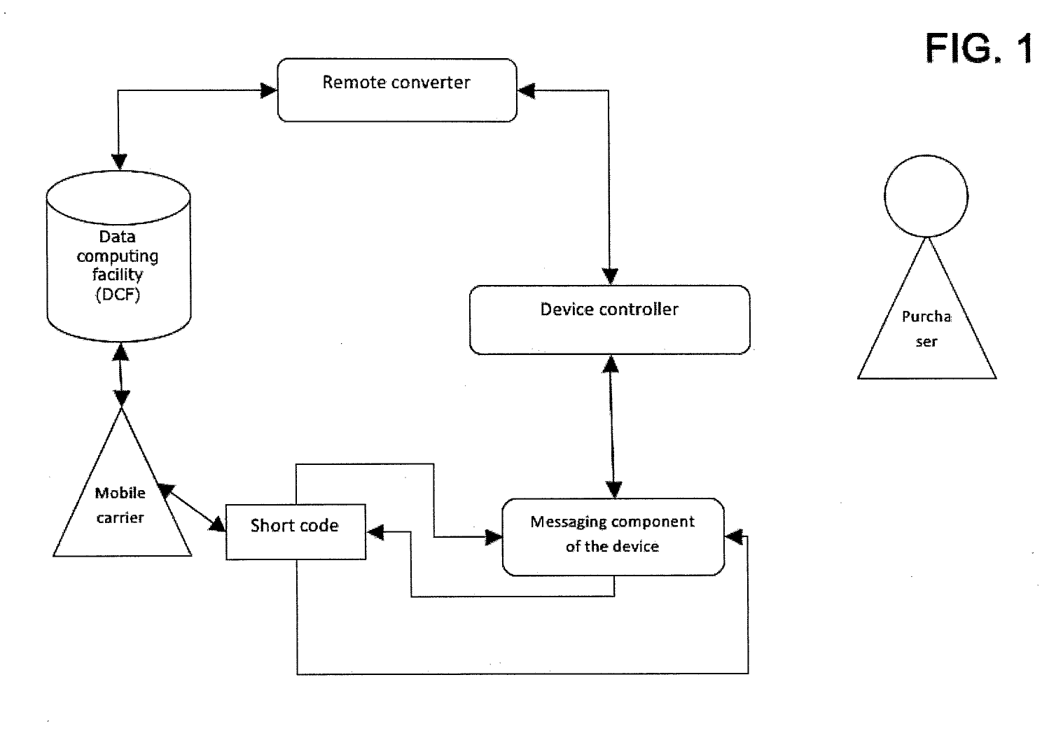

FIG. 2 depicts an illustrative method for facilitating purchases on mobile devices via automatic payment confirmation.

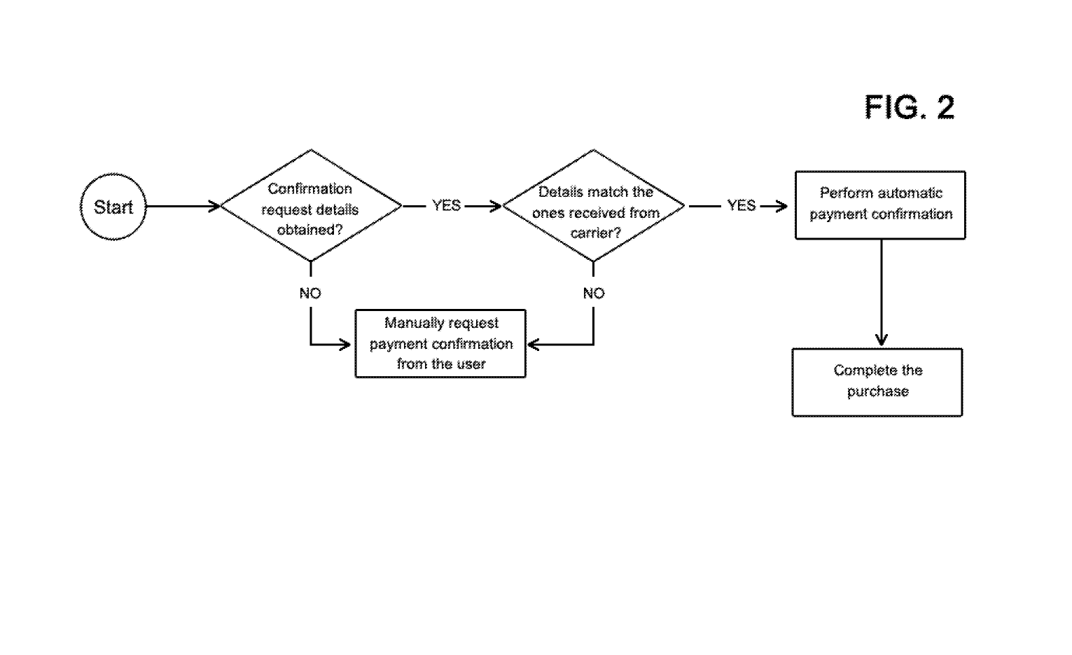

### DETAILED DESCRIPTION OF THE INVENTION

A system according to present invention to facilitate mobile purchases via automatic payment confirmation comprises a cloud-stored data computing facility connected to mobile carrier billing infrastructure, a remote converter and a device controller.

Data computing facility is a network-connected system for storing and retrieving payment confirmation details for various carriers. Data computing facility is connected to carrier's billing infrastructure in order to maintain the information up to date.

Remote converter is a network-connected system for requesting payment confirmation details and transmitting them to the device. Remote converter is configured to communicate with corresponding device controller in different languages and protocols. Remote converter is directly connected to data computing facility.

Device controller is a network-connected system that integrates with mobile device in order to obtain payment confirmation details from remote converter, initiate carrier payment confirmation process and inform the user about successful purchase. Device controller is designed to interface with mobile device messaging component and mobile device native interface component. Mobile device messaging component is the built-in component of mobile device, responsible for sending, receiving and storing SMS text messages. Native interface component is a built-in component of mobile device for delivering information to user via display.

In case respective controller is not able to integrate with native interface component, a universal HTML5 markup language based web interface is used as communication interface.

Mobile carrier billing infrastructure is a system for initializing, confirming and completing payments by users using carrier billing accounts and systems. System is connected to a short code for communicating with mobile devices via SMS text messages. Short code is a combination of short keyword and short phone numbers provided by mobile to exchange SMS text messages with mobile devices.

A method according to present invention to facilitate mobile purchases via automatic payment confirmation comprises following steps.

1. Device Controller Requests Confirmation Request Details from Remote Converter

Request is made via active Internet network connection. Request includes information that identifies the device and carrier including but not limited to country, carrier name, Mobile Country Code (MCC), Mobile Network Code (MNC) and Mobile Subscriber Integrated Services Digital Network Number (MSISDN) values. In case the device is not identified, a stop command is returned to device controller, which initiates manual payment confirmation process by the user.

2. Remote Converter Requests Confirmation Request Details from DCF. DCF Forwards Confirmation Request Details to Remote Converter.

Remote converter processes the request and information, received from device controller. Confirmation request details for respective country, carrier and subscriber are requested and obtained from data computing facility.

In case no matching payment confirmation details are found in data computing facility, a stop command is returned to device controller, which initiates manual payment confirmation process by the user.

3. Confirmation Request Details are Sent to Device Controller by Remote Converter in XML Format. Device Controller Initiates Carrier Payment Confirmation Process.

Payment confirmation details, that were previously obtained from data computing facility and match mobile device country, carrier and subscriber, are converted to Extensible Markup Language (XML) format and sent to device controller by remote converter.

Device controller initiates carrier payment confirmation process by interfacing with messaging component of mobile device and transmitting a SMS text message to mobile carrier billing infrastructure via the shortcode. Mobile carrier receives and processes the request.

### 4. Mobile Carrier Requests User to Confirm the Payment Via SMS Text Message

Mobile carrier billing infrastructure initiates payment confirmation procedure by sending a SMS text message containing details and instructions on confirming the payment to mobile device messaging component via the short code.

### 5. Carrier's Confirmation Request is Intercepted by Messaging Component and Forwarded to Device Controller.

Incoming SMS text message containing details and instructions on confirming the payment is intercepted by messaging component of the device and forwarded to device controller.

6. Checking Whether the Mobile Carrier's Confirmation Request Details Match the Information Obtained from Remote Converter.

In case mobile carrier's confirmation request details match the information obtained from remote converter, payment confirmation request details are sent to messaging component. In case details do not match, user is asked to confirm the payment manually.

Device controller compares payment confirmations details, previously obtained from remote converter, with payment confirmation details and instructions, obtained from mobile carrier billing infrastructure via incoming SMS text message. In case of a positive match, automatic payment confirmation process is initiated by sending respective payment confirmation request details to messaging component of mobile device.

In case the details, obtained from remote converter, do not match the details, obtained from mobile carrier billing infrastructure, device controller initiates manual payment confirmation process by the user.

### 7. Payment Confirmation Request is Made Via SMS Text Message

A SMS text message is compiled according to payment confirmation request details, previously obtained from device controller, and sent to mobile carrier via the messaging protocol and short code. Mobile carrier billing infrastructure receives the payment confirmation request and processes the payment.

8. Successful Billing Confirmation Request is Made to Messaging Component by Mobile Carrier Billing Infrastructure Informing about Successful Billing.

Mobile carrier billing infrastructure initiates billing confirmation delivery procedure by sending a SMS text message containing payment details to mobile device messaging component via the short code.

### 9. Billing Confirmation is Forwarded to Device Controller

Incoming SMS text message containing payment details is intercepted by messaging component of the device and forwarded to device controller. Device controller initiates payment and purchase completion procedure that includes informing the user about successful purchase via native interface component of mobile device and delivering the purchased goods or services.

In alternative embodiments to enable the device controller to automatically handle payment confirmation requests instead of and/or in addition to SMS text message other opt-in payment confirmation technologies are used, for example receiving and delivering a payment confirmation PIN code to mobile carrier billing infrastructure, making HTTP request to URL's, sent by mobile carrier or entering a ZIP code. Such ability can be added by defining and storing new payment confirmation rules and details in data computing facility and upgrading device controller to be able to handle sending PIN codes via SMS texts messages and performing HTTP requests to previously obtained URL. Remaining steps of the original method remains the same.

1. A system to facilitate purchases on mobile devices via automatic payment confirmation comprises data computing facility, mobile carrier billing infrastructure, plurality of converters, plurality of controllers, device controller, messaging component of the device, wherein data computing facility is connected to mobile carrier billing infrastructure, respective controller integrates with platform's native interface, converter is configured to communicate with a corresponding device controller for mobile devices and platforms through an internet connection, respective payment confirmation request data is served to respective converter by the computing facility, payment confirmation request via opt-in is performed by respective controller through interrogating with messaging component, each controller is designed to integrate with respective device's platform interface based on device's operating system.

2. The system of claim 1, wherein data computing facility is a network connected system for storing and retrieving payment confirmation details for various carriers.

3. The system of claim 1, wherein converter is remote converter or network connected system for requesting payment confirmation details and transmitting payment confirmation details to the device.

4. The system of claim 1, wherein converter is directly connected to data computing facility.

5. The system of claim 1, wherein device controller is a network connected system that integrates with mobile device in order to obtain payment confirmation details from remote converter, initiate carrier payment confirmation process and inform the user about successful purchase.

6. The system of claim 1, wherein device controller is designed to interface with mobile device messaging component and mobile device native interface component.

7. The system of claim 1, wherein mobile carrier billing infrastructure is a system for initializing, confirming and completing payments by users using carrier billing accounts and systems.

8. The system of claim 1, wherein the system is connected to a short code for communicating with mobile devices via SMS text messages.

9. The system of claim 1, wherein the respective controller of confirmation button handles the process of performing the payment confirmation request via SMS text message and the confirmation request is done in the background without the need of any involvement of the user.

10. The system of claim 1, wherein the payment is confirmed by mobile carrier when a confirmation dialogue is displayed to user using native platform interface.

11. The system of claim 1, wherein the computing facility uses technical information.

12. A method to facilitate purchases on mobile devices via automatic payment confirmation comprises following steps:
requesting confirmation request details from remote converter by device controller;
requesting confirmation request details from data computing facility by remote converter;
forwarding confirmation request details to remote converter by data computing facility;
sending confirmation request details to device controller by remote converter;
initiating carrier payment confirmation process by device controller;
requesting user to confirm the payment by mobile carrier;
Intercepting carrier's confirmation request by messaging component and forwarding to device controller;
checking whether the mobile carrier's confirmation request details match the information obtained from remote converter;
requesting payment confirmation via;
sending successful billing confirmation request to messaging component by mobile carrier;
forwarding billing confirmation to device controller delivering the purchased goods or services.

13. The method of claim 12, wherein requesting the payment confirmation via SMS text message, a payment confirmation PIN code, making HTTP request to URL's, sent by mobile carrier or entering a ZIP code.

14. The method of claim 12, wherein the mobile carrier's confirmation request details match the information obtained from remote converter, the payment confirmation request details are sent to messaging component.

15. The method of claim 12, wherein the mobile carrier's confirmation request details do not match, user is asked to confirm the payment manually.

16. The method of claim 12, wherein requesting confirmation request details identifies the device and carrier and/or the device country, carrier and subscriber and/or payment confirmation details.

17. The method of claim 12, wherein the message containing details and instructions on confirming the payment is intercepted by messaging component of the device and forwarded to device controller.

18. The method of claim 12, wherein in case of a positive match payment confirmation process is initiated by sending respective payment confirmation request details to messaging component of mobile device.

19. The method of claim 12, wherein in case the payment confirmation request details do not match device controller initiates manual payment confirmation process by the user.

20. The method of claim 12, wherein billing confirmation delivery procedure is initiated by sending a SMS text message containing payment details to mobile device messaging component via the short code.
